(19) United States
(12) Patent Application Publication
(10) Pub. No.: US 2026/0168617 A1
(43) Pub. Date: Jun. 18, 2026

(54) ROTATION DEVICE AND CEILING-MOUNTED BRACKET

(71) Applicant: Bestqi Innovation Technology (Shenzhen) Co., Ltd, Shenzhen (CN)

(72) Inventors: Yuan WANG, Shenzhen (CN); Changgan SHEN, Shenzhen (CN)

(73) Assignee: Bestqi Innovation Technology (Shenzhen) Co., Ltd, Shenzhen (CN)

(21) Appl. No.: 19/420,013

(22) Filed: Dec. 15, 2025

(30) Foreign Application Priority Data
Dec. 16, 2024 (CN) 2024230992414

(51) Int. Cl. F16M 13/02; F16M 11/10; F16M 11/20

(52) U.S. Cl. CPC F16M 13/027; F16M 11/10; F16M 11/2014

(57) ABSTRACT

A rotation device includes a housing, a drive assembly, and a connecting plate. The housing is configured to be mounted to a ceiling. The drive assembly includes a drive member, a first transmission member, and a second transmission member. The drive member is at least partially arranged in the housing. The first transmission member is in transmission engagement with the second transmission member. The drive member is connected to the first transmission member. The second transmission member is connected to the housing and is rotatable relative to the housing. The connecting plate is arranged on an outer side of the housing and is fixedly connected to the second transmission member. The drive member is configured to drive, through the first transmission member, the second transmission member to rotate to drive the connecting plate to rotate.

### CROSS-REFERENCE TO RELATED APPLICATION

This application is based on and claims the benefit of priority from Chinese Patent Application No. 2024230992414, filed on 16 Dec. 2024, the entirety of which is incorporated by reference herein.

### TECHNICAL FIELD

The present disclosure relates to the technical field of accessories for electronic devices, and in particular, to a rotation device and a ceiling-mounted bracket.

### BACKGROUND

A ceiling-mounted bracket is a type of bracket used to suspend a television or other electronic device with a display and wires on the ceiling, such that the electronic device can be positioned at a prominent location, making it easier for a user to access information displayed on the display. Ceiling-mounted brackets are commonly used in exhibition halls, waiting lounges, multimedia rooms, or homes with specific requirements.

In the related art, electronic devices are typically fixed in a predetermined direction for viewing by a user, which provides limited freedom to adjust the viewing direction for the user, and is therefore unfavorable for meeting the viewing requirements of the user.

### SUMMARY

The present disclosure aims to at least solve one of the technical problems in the related art. Accordingly, the present disclosure provides a rotation device and a ceiling-mounted bracket to improve the flexibility of adjusting the viewing direction of an electronic device.

In accordance with a first aspect of the present disclosure, an embodiment provides a rotation device, configured to drive a display bracket mounted with a display to rotate, and including:
a housing, configured to be mounted to a ceiling;
a drive assembly, including a drive member, a first transmission member, and a second transmission member, where the drive member is at least partially arranged in the housing, the first transmission member is in transmission engagement with the second transmission member, the drive member is connected to the first transmission member, and the second transmission member is connected to the housing and is rotatable relative to the housing; and
a connecting plate, configured to be connected with the display bracket and arranged on an outer side of the housing and fixedly connected to the second transmission member, where the drive member is configured to drive, through the first transmission member, the second transmission member to rotate to drive the connecting plate to rotate.

The rotation device according to the embodiment of the present disclosure at least has the following advantages.

The drive member drives the first transmission member and the second transmission member that are in transmission engagement to rotate, to cause the connecting plate to rotate, such that the rotation device can adjust the orientation of the display, thereby better meeting the viewing requirements of a user on the display in different usage scenarios. In addition, the drive member is stationary relative to the housing, and the drive member drives the connecting plate to rotate to cause the connecting plate to rotate relative to the housing. Because an existing hanging bracket without a rotation function is usually connected to a ceiling by a flat mounting panel thereof which can be directly connected to the connecting plate of the present disclosure. This makes it remarkably simple and convenient to retrofit an ordinary hanging bracket without a rotation function, enabling the ordinary hanging bracket to rotate the display.

According to some embodiments of the present disclosure, the first transmission member is a driving gear, the second transmission member includes a driven gear and a transmission shaft, an output shaft of the drive member extends toward the connecting plate and is connected to the driving gear, the driving gear is engaged with the driven gear, the transmission shaft is mounted on the housing, the driven gear is connected to the transmission shaft, and the connecting plate is connected to the driven gear.

According to some embodiments of the present disclosure, the first transmission member is a worm, the second transmission member includes a worm wheel and a transmission shaft, an output shaft of the drive member is connected to the worm, the worm is engaged with the worm wheel, the transmission shaft is mounted on the housing and is rotatable relative to the housing, the worm wheel is fixedly connected to the transmission shaft, and the connecting plate is connected to the worm wheel or the connecting plate is connected to the transmission shaft.

According to some embodiments of the present disclosure, the transmission shaft is provided with a wire gathering channel extending through the transmission shaft in an axial direction of the transmission shaft and configured for a wire to pass through.

According to some embodiments of the present disclosure, the rotation device includes a first bearing arranged between the driven gear and the housing.

According to some embodiments of the present disclosure, the rotation device includes a restraint member arranged between the driving gear and the housing.

According to some embodiments of the present disclosure, the rotation device includes a micro switch and an induction sheet, one of the housing and the connecting plate is provided with the micro switch, the other of the housing and the connecting plate is provided with the induction sheet, the micro switch is configured to control the drive assembly to stop rotation, and the induction sheet is configured to trigger the micro switch.

According to some embodiments of the present disclosure, the rotation device further includes an angle sensor configured for detecting a rotation angle of the connecting plate, the angle sensor is selected from a group consisting of a potentiometric angle sensor, an optical encoder, a magnetic encoder, a resolver, a capacitive angle sensor, or a gyroscope.

In accordance with a second aspect of the present disclosure, an embodiment provides a ceiling-mounted bracket, including:
the rotation device according to any one of the above embodiments; and
a display bracket, including a mounting frame and a folding mechanism, where the mounting frame is configured to mount the display, the mounting frame is arranged on the folding mechanism, and the folding mechanism is configured to drive the mounting frame to rotate about a second rotational axis to unfold or fold the mounting frame; and
where the connecting plate is detachably connected to the folding mechanism, the drive assembly of the rotation device is able to drive the folding mechanism to rotate about a first rotational axis, to cause the mounting frame to respectively rotate about the first rotational axis and the second rotational axis, and the first rotational axis is arranged intersecting the second rotational axis.

According to some embodiments of the present disclosure, the folding mechanism includes a rotating member, a folding member, a connecting rod assembly, and a telescopic push rod, the connecting plate is detachably connected to the rotating member, the folding member is rotatably connected to the rotating member by the connecting rod assembly, one end of the telescopic push rod in an axial direction of the telescopic push rod is rotatably connected to the folding member, the other end of the telescopic push rod in the axial direction of the telescopic push rod is rotatably connected to the rotating member, the telescopic push rod is configured to drive the folding member to rotate about the second rotational axis relative to the rotating member, and the mounting frame is arranged on the folding member.

According to some embodiments of the present disclosure, the connecting rod assembly includes a first hinge member, a second hinge member, and a third hinge member, two ends of the first hinge member are respectively hinged to the rotating member and the folding member, two ends of the second hinge member are respectively hinged to the first hinge member and the third hinge member, one end of the third hinge member is hinged to the folding member, and the other end of the third hinge member is slidably hinged to a slide groove on the rotating member.

According to some embodiments of the present disclosure, the display bracket is provided with a wiring channel configured to accommodate at least a portion of a wire of the display.

According to some embodiments of the present disclosure, the wiring channel includes a wire groove formed on the display bracket.

According to some embodiments of the present disclosure, the display bracket includes a plurality of wire clamps, the plurality of wire clamps are arranged on the folding mechanism in intervals and are each provided with a through hole, and the through holes of the plurality of wire clamps jointly form the wiring channel.

Other aspects and advantages of the present disclosure will be given in the following description, some of which will become apparent from the following description or may be learned from practices of the present disclosure.

### BRIEF DESCRIPTION OF DRAWINGS

The present disclosure will be further described below with reference to the accompanying drawings and embodiments. In the drawings:

FIG. 1 is a schematic structural diagram of a ceiling-mounted bracket according to an embodiment of the present disclosure, where the ceiling-mounted bracket is in an unfolded state and a wire is denoted by a dashed line;

FIG. 2 is a schematic structural top view of a ceiling-mounted bracket according to an embodiment of the present disclosure;

FIG. 3 is a schematic structural cross-sectional view taken along line A-A in FIG. 2, where a wire is denoted by a dashed line;

FIG. 4 is a schematic structural enlarged view of part B in FIG. 3;

FIG. 5 is a schematic exploded view of a rotating assembly of the ceiling-mounted bracket according to an embodiment of the present disclosure;

FIG. 6 is a schematic exploded view of a rotating assembly of the ceiling-mounted bracket according to an embodiment of the present disclosure; and

FIG. 7 is a schematic structural diagram of a ceiling-mounted bracket according to an embodiment of the present disclosure, where the ceiling-mounted bracket is in a folded state, a protective cover and a connecting plate are shown in perspective and denoted by dashed lines, and a wire is denoted by a dashed line.

### REFERENCE NUMERALS

100. rotation device; 1. housing; 2. drive assembly; 21. drive member; 22. first transmission member; 221. worm; 23. second transmission member; 231. transmission shaft; 231a. wire gathering channel; 232. worm wheel; 3. connecting plate; 4. first bearing; 5. restraint member; 6. micro switch; 7. protective cover; 8. passive bearing; 9. induction sheet; 10. reversing gear set; 11. output shaft; 12. gourd hole; 13. circular screw hole; 200. display bracket; 210. folding mechanism; 211. rotating member; 211a. slide groove; 212. folding member; 213. telescopic push rod; 214. connecting rod assembly; 2141. first hinge member; 2142. second hinge member; 2143. third hinge member; 220. mounting frame; 230. wire clamp; 230a. through hole; 300. wire.

### DETAILED DESCRIPTION

Embodiments of the present disclosure will be described in detail hereinafter in conjunction with accompanying drawings in which the same or like reference characters refer to the same or like elements or elements having the same or like functions throughout. The embodiments described below by reference to the accompanying drawings are illustrative and are intended for illustrating only and are not to be construed as limiting the present disclosure.

In the description of the present disclosure, it should be understood that for the description of orientations, the orientation or positional relationships indicated by the terms such as “upper,” “lower,” “front,” “rear,” “left,” “right,” and the like are based on orientation or positional relationships shown in the accompanying drawings, and are used only for ease and brevity of illustration and description, rather than indicating or implying that the mentioned apparatus or element must have a particular orientation or must be constructed and operated in a particular orientation. Therefore, such terms should not be construed as limiting of the present disclosure.

It should be understood that in the description of the embodiments of the present disclosure, the term “several” means one or more, the term “plurality of” (or multiple) means two or more. The term such as “greater than,” “less than,” “exceed” or variants thereof prior to a number or series of numbers is understood to not include the number adjacent to the term. The term such as “above,” “below,” “within” or variants thereof prior to a number or series of numbers is understood to include the number adjacent to the term. If used herein, the terms such as “first,” “second,” and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

In the description of the specification, the description with reference to the terms such as “an embodiment,” “some embodiments,” “example embodiments,” “example,” “specific example,” or “some examples” and so on means that specific features, structures, materials or characteristics described in connection with the embodiment or example are included in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments.

In the related art, a ceiling-mounted bracket typically can only fix an electronic device with a display in a predetermined direction for viewing by a user, or can be unfolded and folded in one direction to adjust the angle of the electronic device in the vertical direction, but does not allow for the adjustment of the orientation of the electronic device, failing to meet the viewing requirements of the user on the electronic device in different usage scenarios.

In view of the above, an embodiment of the present disclosure provides a rotation device, where a drive assembly 2 drives a connecting plate 3 to rotate to drive an electronic device to rotate, such that the rotation device can adjust the orientation of the electronic device, thereby better meeting the viewing requirements of a user on the electronic device in different usage scenarios. In addition, the connecting plate 3 of the present disclosure can be connected to an ordinary hanging bracket, to enable the ordinary hanging bracket to rotate the electronic device.

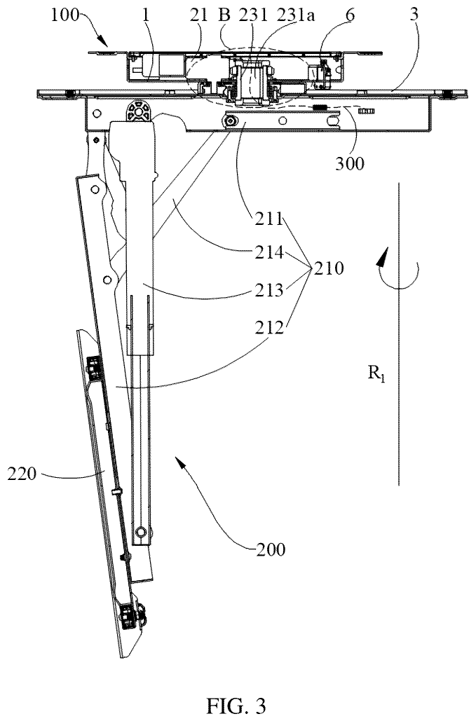

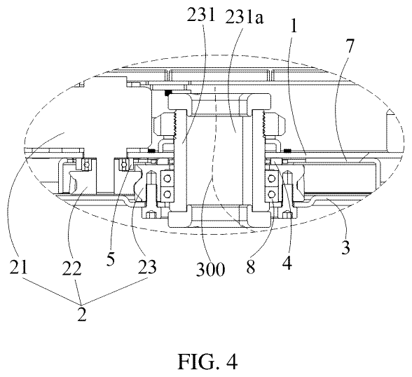

FIG. 3 and FIG. 4 show a rotation device 100 according to an embodiment of the present disclosure. The rotation device 100 includes a housing 1, a drive assembly 2, and a connecting plate 3. The housing 1 is configured to be mounted to a ceiling, i.e., the housing 1 is stationary relative to the ceiling. The housing 1 may be made of metal or other materials having a certain strength. The drive assembly 2 includes a drive member 21, a first transmission member 22, and a second transmission member 23. The drive member 21 is at least partially arranged in the housing 1, such that the drive member 21 remains stationary relative to the housing 1. The first transmission member 22 is in transmission engagement with the second transmission member 23. The drive member 21 is connected to the first transmission member 22. The second transmission member 23 is connected to the housing 1 and is rotatable relative to the housing 1, to enable the drive member 21 to drive the second transmission member 23 to rotate. The connecting plate 3 is arranged on an outer side of the housing 1 and is fixedly connected to the second transmission member 23. The connecting plate 3 may be made of metal or other materials having a certain strength. The drive member 21 drives, through the first transmission member 22, the second transmission member 23 to rotate to drive the connecting plate 3 to rotate, to enable the connecting plate 3 to rotate relative to the housing 1.

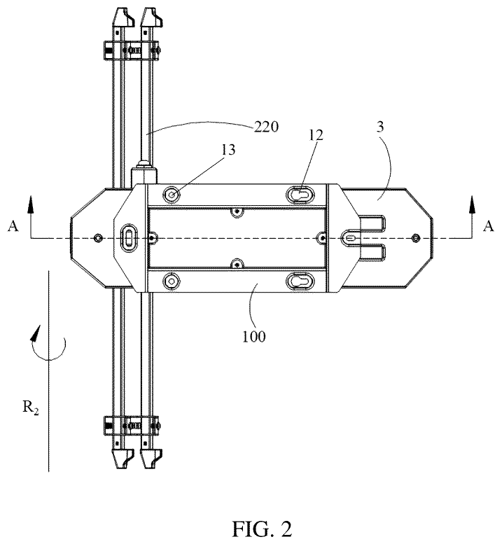

For example, referring to FIG. 2, the housing 1 may be connected to the ceiling by screws, and at least part of screw holes on the housing 1 may be gourd holes 12 having a large diameter end and a small diameter end, while the remaining ones are circular screw holes 13. In the process of connecting the housing 1 to the ceiling by screws, firstly, screws are mounted at the corresponding positions on the ceiling. The large diameter end of each gourd hole 12 on the housing 1 is aligned with the respective screw, allowing the screw to pass through the large diameter end of the gourd hole 12. Then, the rotation device 100 is moved so that the screws travel from the large diameter end to the small diameter end of the gourd holes 12. Through the cooperation of the screws and the gourd holes 12, the rotation device 100 is preliminarily fixed. The remaining screws are mounted in the remaining circular screw holes 13, thus connecting the housing 1 to the ceiling by the screws.

In the embodiments of the present disclosure, the drive member 21 drives the first transmission member 22 and the second transmission member 23 that are in transmission engagement to rotate, to cause the connecting plate 3 to rotate, such that the rotation device 100 can adjust the orientation of the electronic device, thereby better meeting the viewing requirements of a user on the electronic device in different usage scenarios. In addition, the drive member 21 is stationary relative to the housing 1, and the drive member 21 drives the connecting plate 3 to rotate to cause the connecting plate 3 to rotate relative to the housing 1. Because an existing hanging bracket without a rotation function is usually connected to a ceiling by a flat mounting panel thereof which can be directly connected to the connecting plate 3 of the present disclosure. This makes it remarkably simple and convenient to retrofit an ordinary hanging bracket without a rotation function, enabling the ordinary hanging bracket to rotate the display.

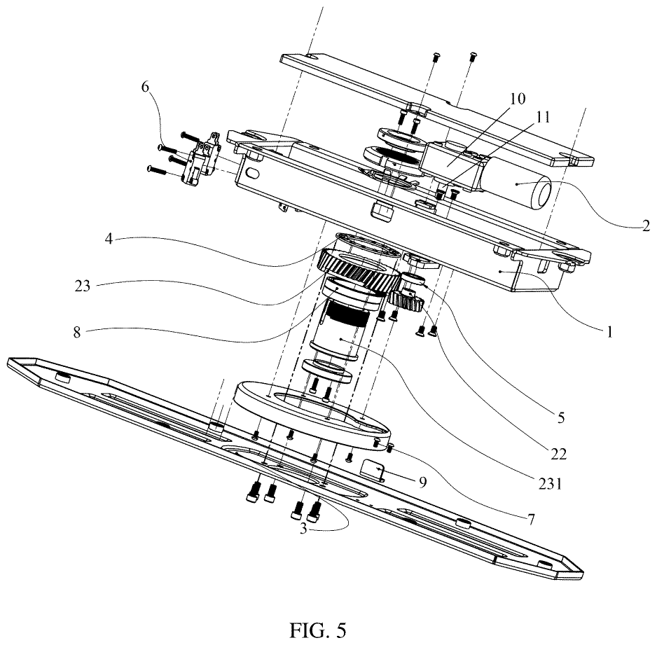

In an embodiment, referring to FIG. 3 to FIG. 7, the first transmission member 22 is a driving gear, and the second transmission member 23 includes a driven gear and a transmission shaft 231. An output shaft of the drive member 21 extends toward the connecting plate 3 and is connected to the driving gear. The drive member 21 may include a speed reducer and a motor, such that the drive member 21 drives the driving gear to rotate at a low speed with a large torque. Alternatively, the drive member 21 may be a motor. The driving gear is engaged with the driven gear, the transmission shaft 231 is mounted on the housing 1, the driven gear is connected to the transmission shaft 231, and the connecting plate 3 is connected to the driven gear, such that the connecting plate 3 can be driven to rotate. As such, the driven gear has a transmission function and is connected to the connecting plate 3, which is conducive to reducing the number of related connecting mechanisms of the rotation device 100, thereby reducing the thickness of the rotation device 100.

For example, the transmission shaft 231 is rotatably connected to the housing 1, and the driven gear is fixedly connected to the transmission shaft 231, such that the driving gear can drive the transmission shaft 231 to rotate through the driven gear. The connecting plate 3 may be connected to the driven gear, or may be connected to the transmission shaft, such that the connecting plate 3 can rotate under the driving of the driving gear.

For example, as shown in FIG. 4, the transmission shaft 231 is fixedly connected to the housing 1, and the driven gear is rotatably connected to the transmission shaft 231, the driven gear can rotate relative to the transmission shaft 231 under the driving of the driving gear, and the connecting plate 3 is connected to the driven gear, such that the connecting plate 3 can rotate under the driving of the driving gear. A passive bearing 8 may be arranged between the driven gear and the transmission shaft 231. The arrangement of the passive bearing 8 ensures the smooth rotation of the driven gear and prevents the generation of abnormal noise during rotation of the connecting plate 3.

For example, the drive member 21 is arranged in a horizontal direction to reduce the thickness of the rotation device 100, a rotational axis of the rotational shaft of the drive member 21 is arranged in the horizontal direction, the rotation device 100 further includes a reversing gear set 10. The reversing gear set 10 is drivingly connected to the rotational shaft of the drive member 21. The reversing gear set 10 includes an output shaft 11 that extends vertically and is connected to the driving gear. The reversing gear set 10 is configured to convert the horizontal rotation of the drive member 21 into the vertical rotation of the output shaft 11, such that the drive member 21 can drive the driving gear to rotate, and a rotational axis of the driving gear is arranged in a vertical direction.

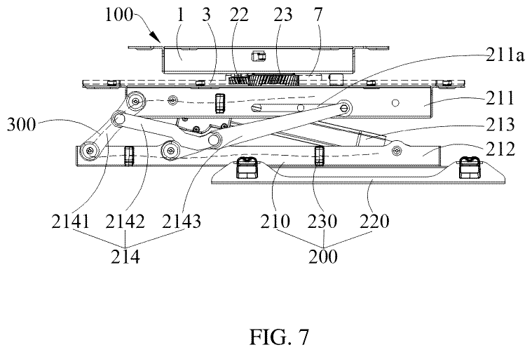

For example, referring to FIG. 4 and FIG. 7, the drive member 21 drives the driving gear to rotate to drive the driven gear to rotate, and the connecting plate 3 is connected to a side of the driven gear facing away from the housing 1, such that the connecting plate 3 can also rotate.

The driving gear and the driven gear may both be spur gears. Alternatively, the driving gear and the driven gear may also be helical gears as shown in FIG. 7 to reduce the impact force during engagement between the driving gear and the driven gear.

For example, referring to FIG. 3 and FIG. 4, the drive member 21 includes a motor. The motor body is arranged in the housing 1. The output shaft of the drive member 21 extends out of a surface of the housing 1 at a side adjacent to the connecting plate 3. The driving gear is arranged between the housing 1 and the connecting plate 3 and is fixedly connected to the output shaft. The driven gear is arranged outside the housing 1 and is engaged with the driving gear. The transmission shaft 231 extends out of the surface of the housing 1 at the side adjacent to the connecting plate 3. The driven gear is connected to a portion of the transmission shaft 231 protruding out of the housing 1.

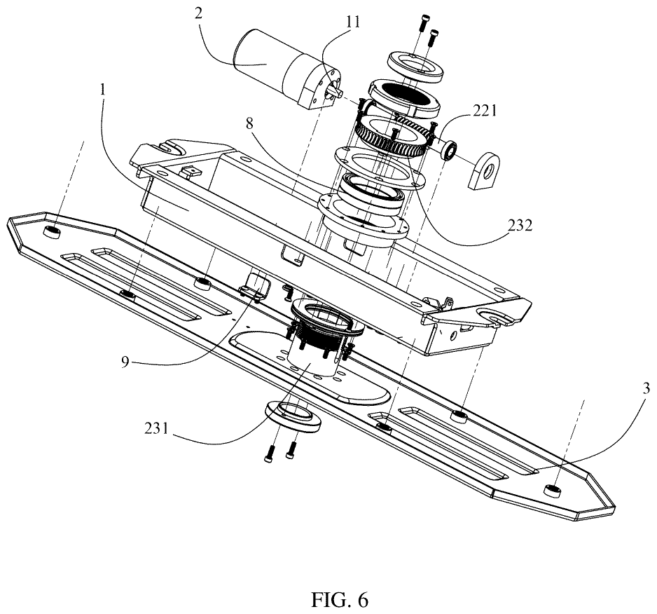

It can be understood that in the present disclosure, the first transmission member 22 is not limited to being the driving gear, and the second transmission member 23 is not limited to including the driven gear and the transmission shaft 231. In an embodiment, referring to FIG. 6, the first transmission member is a worm 221, the second transmission member 23 includes a worm wheel 232 and a transmission shaft 231, an output shaft of the drive member 21 is connected to the worm 221, the worm 221 is engaged with the worm wheel 232, the transmission shaft 231 is mounted on the housing 1 and is rotatable relative to the housing 1, the worm wheel 232 is fixedly connected to the transmission shaft 231, and the connecting plate 3 is connected to the worm wheel 232 or the connecting plate 3 is connected to the transmission shaft 231, such that the connecting plate 3 can be driven to rotate. As such, the worm wheel 232 has a transmission function and is connected to the connecting plate 3, which is conducive to reducing the number of related connecting mechanisms of the rotation device 100, thereby reducing the thickness of the rotation device 100.

It should be noted that when the worm 221 is used as the first transmission member 22, the worm 221 and the worm wheel 232 themselves can be used to transmit motion and power between the two staggered shafts, so the drive member 21 can be arranged in the horizontal direction and the rotation device 100 does not need to include the reversing gear set.

In an embodiment, referring to FIG. 3 and FIG. 4, the transmission shaft 231 is provided with a wire gathering channel 231a extending through the transmission shaft 231 in an axial direction of the transmission shaft 231 and configured for a wire 300 of the electronic device to pass through. As such, the wire 300 of the electronic device can be routed inside of the housing 1, and when the connecting plate 3 rotates, the wire 300 accommodated in the wire gathering channel 231a hardly moves relative to the wire gathering channel 231a, such that the possibility of the wire 300 being pulled is reduced, and the possibility of breakage of the wire 300 due to tangling is reduced.

In an embodiment, referring to FIG. 4, the rotation device 100 includes a first bearing 4 arranged between the driven gear and the housing 1 to improve the stability of the driven gear during rotation.

For example, referring to FIG. 4, the first bearing 4 may be a thrust needle roller bearing. One end of the thrust needle roller bearing in an axial direction of the thrust needle roller bearing is connected to the housing 1, and the other end of the thrust needle roller bearing in the axial direction of the thrust needle roller bearing is connected to the driven gear, to fill a gap between the driven gear and the housing 1. The rotation of the connecting plate 3 driven by the drive assembly 2 is usually eccentric rotation, and the arrangement of the thrust needle roller bearing in the gap between the housing 1 and the driven gear can improve the stability of the driven gear during eccentric rotation.

It can be understood that the rotation device 100 is not limited to including the first bearing 4.

In an embodiment, referring to FIG. 4, the rotation device 100 includes a restraint member 5 arranged between the driving gear and the housing 1 to reduce an axial force of the output shaft of the drive member 21 during engagement between the driving gear and the driven gear.

For example, referring to FIG. 4, the restraint member 5 may include an active bearing and an active bearing housing. During the assembly of the rotation device 100, the active bearing may be mounted in the active bearing housing, and then the driving gear may be mounted in the active bearing. The output shaft of the drive member 21 is inserted into the driving gear, and a screw is provided at a corresponding position to firmly mount the driving gear to the output shaft of the drive member 21.

It can be understood that the rotation device 100 is not limited to including the restraint member 5.

In an embodiment, referring to FIG. 3, the rotation device 100 includes a micro switch 6 and an induction sheet 9. One of the housing 1 and the connecting plate 3 is provided with the micro switch, and the other of the housing 1 and the connecting plate 3 is provided with the induction sheet 9. The micro switch 6 is configured to control the drive assembly 2 to stop rotation. For example, the micro switch 6 may be arranged in the housing 1, such that a wire harness through which the micro switch 6 controls the drive member 21 to stop is also arranged in the housing 1 without passing through the wire gathering channel 231a of the transmission shaft 231. As such, the number of wires 300 passing through the wire gathering channel 231a of the transmission shaft 231 is reduced, and therefore the possibility of wear and breakage of the wire 300 due to tangling caused by rotation is reduced. The induction sheet 9 is configured to trigger the micro switch 6. For example, the induction sheet 9 is arranged on a side of the connecting plate 3 adjacent to the drive member 21. The induction sheet 9 is configured to trigger the micro switch 6 to control the drive assembly 2 to stop rotation, so as to define a starting point and an end point of rotation of the connecting plate 3 by the induction sheet 9. When the connecting plate 3 rotates, the induction sheet 9 arranged on the connecting plate 3 also rotates accordingly. When the induction sheet 9 touches the micro switch 6, it will trigger the micro switch 6, and the micro switch 6 immediately stops the drive member 21. For example, the rotation angle of the connecting plate 3 can be adjusted by changing the mounting position of the induction sheet 9. The angle by which the connecting plate 3 can rotate may be less than or equal to 360°. Under the drive of the drive assembly 21, the connecting plate 3 rotates clockwise by 360° to the end point. The connecting plate 3 can then be driven by the drive assembly 21 to rotate counter-clockwise by 360° to return to the starting point.

It can be understood that the rotation device 100 is not limited to including the micro switch 6 and the induction sheet 9, and the rotation device 100 may also include an angle sensor having the same function, such as a potentiometric angle sensor, an optical encoder, a magnetic encoder, a resolver, a capacitive angle sensor, or a gyroscope, and use the angle sensor to detect the rotation angle of the connecting plate 3 and, based on the rotation angle, control the drive member 21 to stop rotation. The angle sensor is not limited to the types listed above, and any other sensor capable of detecting rotation angle may be used. The stop of the drive member 21 may also be controlled by transmission ratio conversion, Hall feedback, or the like.

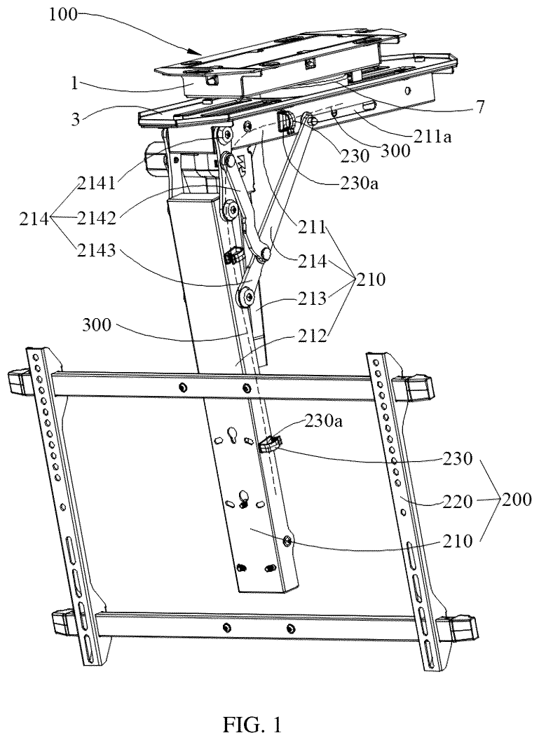

In accordance with a second aspect of the present disclosure, an embodiment provides a ceiling-mounted bracket, including the rotation device 100 according to the above embodiments and a display bracket 200. FIG. 1 shows the ceiling-mounted bracket in an unfolded state and FIG. 7 shows the ceiling-mounted bracket in a folded state. Specifically, the display bracket 200 includes a mounting frame 220 and a folding mechanism 210. The mounting frame 220 is configured to mount the electronic device having a display and a wire 300, such that the electronic device can be arranged at a prominent position, making it easier for a user to access information displayed on the display. The electronic device may be a television, a display device, or a tablet computer. The wire 300 may include a power cord and a signal cable of the electronic device, and the electronic device can operate normally through the wire 300. The mounting frame 220 may be made of plastic or metal. The electronic device may be mounted on the mounting frame 220 by screw connection, snap-fit, or the like. The mounting frame 220 is arranged on the folding mechanism 210, such that the electronic device can be hung at a more prominent predetermined position. The folding mechanism 210 is configured to drive the mounting frame 220 to rotate about a second rotational axis, to unfold or fold the mounting frame 220.

The connecting plate 3 is detachably connected to the folding mechanism 210, and the drive assembly 2 of the rotation device 100 can drive the folding mechanism 210 to rotate about a first rotational axis. Through the rotation device 100 and the folding mechanism 210, the mounting frame 220 can respectively rotate about the first rotational axis and the second rotational axis, such that the electronic device can respectively rotate about the first rotational axis and the second rotational axis. As such, the viewing requirements of a user on the electronic device in different usage scenarios can be met. The first rotational axis is arranged intersecting the second rotational axis.

For example, referring to FIG. 1, the mounting frame 220 may be detachably connected to the folding mechanism 210 by screws. When the ceiling-mounted bracket of the present disclosure is delivered to a customer, the mounting frame 220, the folding mechanism 210, and the rotation device 100 may be separate from each other, thus facilitating the packaging and transportation of the ceiling-mounted bracket, and allowing the customer to adjust the position where the mounting frame 220 is mounted on the folding mechanism 210 according to actual requirements. Alternatively, the mounting frame 220 and the folding mechanism 210 may be connected together, allowing the customer to directly mount an electronic device on the mounting frame 220.

For example, a rotational axis shown by R₁ in FIG. 3 is the first rotational axis, and a rotational axis shown by R₂ in FIG. 2 is the second rotational axis.

For example, the first rotational axis may be arranged perpendicular to the second rotational axis.

It can be understood that the connecting plate 3 is detachably connected to the folding mechanism 210. During mounting, the user can decide, on the basis of actual needs, whether or not to combine the rotation device 100 with the display bracket 200. For example, the rotation device 100 may be omitted, and the display bracket 200 may be directly fixedly connected to a ceiling alone. In this configuration, the electronic device can be unfolded and folded only about the second rotational axis. Alternatively, the user may combine the rotation device 100 with the display bracket 200. In this configuration, the electronic device can respectively rotate about the first rotational axis and the second rotational axis, to change the position and orientation of the electronic device.

In an embodiment, referring to FIG. 1, FIG. 3, and FIG. 7, the folding mechanism 210 includes a rotating member 211, a folding member 212, a connecting rod assembly 214, and a telescopic push rod 213. The connecting plate 3 is detachably connected to the rotating member 211, such that the rotating member 211 can remain stationary relative to the connecting plate 3. The folding member 212 is rotatably connected to the rotating member 211 by the connecting rod assembly 214. One end of the telescopic push rod 213 in an axial direction of the telescopic push rod 213 is rotatably connected to the folding member 212, and the other end of the telescopic push rod 213 in the axial direction of the telescopic push rod 213 is rotatably connected to the rotating member 211 to drive the folding member 212 to rotate about the second rotational axis relative to the rotating member 211. Therefore, the folding mechanism 210 has a simple structure. The mounting frame 220 is arranged on the folding member 212 such that the mounting frame 220 can rotate about the second rotational axis.

In an embodiment, referring to FIG. 1, FIG. 3, and FIG. 7, the connecting rod assembly 214 includes a first hinge member 2141, a second hinge member 2142, and a third hinge member 2143, two ends of the first hinge member 2141 are respectively hinged to the rotating member 211 and the folding member 212, two ends of the second hinge member 2142 are respectively hinged to the first hinge member 2141 and the third hinge member 2143, one end of the third hinge member 2143 is hinged to the folding member 212, and the other end of the third hinge member 2143 is slidably hinged to a slide groove 211a on the rotating member 211. FIG. 7 shows the ceiling-mounted bracket in the folded state according to an embodiment of the present disclosure. Referring to FIG. 7, one end of the third hinge member 2143 is hinged to the slide groove 211a of the rotating member 211 and located at a right side of the slide groove 211a, the second hinge member 2142 is substantially horizontal, and two ends of the first hinge member 2141 are respectively hinged to the rotating member 211 and the folding member 212. As the telescopic push rod 213 is gradually extended, the folding member 212 is driven by the telescopic push rod 213 to rotate about a point at which the first hinge member 2141 is hinged to the rotating member 211, and a point at which the third hinge member 2143 is hinged to the slide groove 211a is gradually moved leftward to drive the second hinge member 2142 to rotate clockwise, such that the folding member 212 can be lowered as a whole, to achieve the unfolded state of the ceiling-mounted bracket shown in FIG. 1 and FIG. 3.

In an embodiment, referring to FIG. 1 and FIG. 7, the display bracket 200 is provided with a wiring channel configured to accommodate at least a portion of the wire 300 of the electronic device, such that the wire 300 is restrained in the wiring channel. When the drive assembly 2 drives the display bracket 200 to rotate about the first rotational axis, the display bracket 200 remains stationary relative to the wire 300 of the electronic device.

For example, the wire gathering channel 231a is in communication with the wiring channel, and the wire gathering channel 231a and the wiring channel may be used to respectively accommodate different portions of the wire 300.

For example, one portion of the wire 300 is arranged in the wiring channel, another portion of the wire 300 extends into the display bracket 200 and is connected to the outside through the wire gathering channel 231a, such that when the drive assembly 2 drives the display bracket 200 to rotate about the first rotational axis, the wire 300 can remain stationary relative to the display bracket 200 and the transmission shaft 231 respectively, and only twists in a circumferential direction thereof. As such, the wire 300 hardly moves relative to the display bracket 200 and the transmission shaft 231, such that the possibility of the wire 300 being pulled is reduced.

Alternatively, the wire 300 may include a first electric wire and a second electric wire. One end of the first electric wire is provided with a first connection end configured to electrically connect to the first electric wire, and the other end of the first electric wire is provided with a second connection end configured to electrically connect to an external power supply. At least the second electric wire is accommodated in the wire gathering channel 231a. The first connection end of the second electric wire and the first electric wire may be electrically connected to each other in the wire gathering channel 231a. Alternatively, as shown in FIG. 3, the first connection end of the second electric wire and the first electric wire may be electrically connected to each other outside the wire gathering channel 231a, such that when a length of the first electric wire of the electronic device is insufficient to electrically connect to the external power supply, the first electric wire can be electrically connected to the external power supply through the second electric wire. As such, the applicability of the ceiling-mounted bracket is improved.

It should be noted that the display bracket 200 remaining stationary relative to the wire 300 means that the wire 300 hardly moves relative to the display bracket 200.

In the embodiments of the present disclosure, at least a portion of the wire 300 is restrained in the wiring channel of the display bracket 200, such that when the drive assembly 2 drives the display bracket 200 to rotate, the wire 300 can rotate synchronously with the display bracket 200. As such, the display bracket 200, the electronic device, and the wire 300 can rotate synchronously during the rotation of the electronic device, such that the wire 300 is less likely to be pulled, and the possibility of the wire 300 being broken or falling off from a socket is reduced. With at least a portion of the wire 300 being restrained in the wiring channel, aesthetics of the electronic device mounted on the ceiling-mounted bracket can also be improved.

In an embodiment, the wiring channel includes a wire groove formed on the display bracket 200, such that the wire 300 may be arranged in the wire groove of the display bracket 200. The wire 300 may be snap-fitted in the wire groove or may be directly placed in the wire groove, which is not limited herein. Through the arrangement of the wire 300 in the wire groove of the display bracket 200, the wire 300 of the electronic device can be concealed in the display bracket 200, thereby improving aesthetics of the electronic device mounted on the ceiling-mounted bracket.

In an embodiment, referring to FIG. 1 and FIG. 7, the display bracket 200 may further include a plurality of wire clamps 230, each of the wire clamps 230 is provided with a through hole 230a, and the through holes 230a of the wire clamps 230 jointly form the wiring channel. In other words, the wire 300 is passed through the through holes 230a of the wire clamps 230. With the use of the wire clamps 230 to restrain the wire 300, the wire 300 can be firmly restrained in the wiring channel by its internal connection strength.

In the embodiments of the present disclosure, because the wiring channel is jointly formed by the through holes 230a of the plurality of wire clamps 230, the wire 300 of the electronic device can be quickly restrained in the through holes 230a of the plurality of wire clamps 230 by locking and unlocking of the wire clamps 230 at intervals, thus arranging the wire 300 in the wiring channel. As such, the convenience of mounting the wire 300 in the wiring channel is improved.

In an embodiment, referring to FIG. 1 and FIG. 7, the rotation device 100 includes a protective cover 7 surrounding an outer peripheral side of the first transmission member 22 and the second transmission member 23, to reduce the possibility of dust contaminating the first transmission member 22 and the second transmission member 23 and the possibility of lubricant splashing during the engagement between the first transmission member 22 and the second transmission member 23.

The embodiments of the present disclosure have been described in detail above with reference to the accompanying drawings, but the present disclosure is not limited to the above embodiments, and various changes may be made within the knowledge of those having ordinary skills in the art without departing from the gist of the present disclosure. In addition, the embodiments of the present disclosure and the features in the embodiments may be combined with each other without conflict.

What is claimed is:

1. A rotation device, configured to drive a display bracket mounted with a display to rotate, and comprising:
a housing, configured to be mounted to a ceiling;
a drive assembly, comprising a drive member, a first transmission member, and a second transmission member, wherein the drive member is at least partially arranged in the housing, the first transmission member is in transmission engagement with the second transmission member, the drive member is connected to the first transmission member, and the second transmission member is connected to the housing and is rotatable relative to the housing; and
a connecting plate, configured to be connected with the display bracket and arranged on an outer side of the housing and fixedly connected to the second transmission member, wherein the drive member is configured to drive, through the first transmission member, the second transmission member to rotate to drive the connecting plate to rotate.

2. The rotation device of claim 1, wherein the first transmission member is a driving gear, the second transmission member comprises a driven gear and a transmission shaft, an output shaft of the drive member extends toward the connecting plate and is connected to the driving gear, the driving gear is engaged with the driven gear, the transmission shaft is mounted on the housing, the driven gear is connected to the transmission shaft, and the connecting plate is connected to the driven gear.

3. The rotation device of claim 1, wherein the first transmission member is a worm, the second transmission member comprises a worm wheel and a transmission shaft, an output shaft of the drive member is connected to the worm, the worm is engaged with the worm wheel, the transmission shaft is mounted on the housing and is rotatable relative to the housing, the worm wheel is fixedly connected to the transmission shaft, and the connecting plate is connected to the worm wheel or the connecting plate is connected to the transmission shaft.

4. The rotation device of claim 2, wherein the transmission shaft is provided with a wire gathering channel extending through the transmission shaft in an axial direction of the transmission shaft and configured for a wire to pass through.

5. The rotation device of claim 2, further comprising:
a first bearing arranged between the driven gear and the housing.

6. The rotation device of claim 2, further comprising: a restraint member arranged between the driving gear and the housing.

7. The rotation device of claim 1, further comprising a micro switch and an induction sheet, wherein one of the housing and the connecting plate is provided with the micro switch, the other of the housing and the connecting plate is provided with the induction sheet, the micro switch is configured to control the drive assembly to stop rotation, and the induction sheet is configured to trigger the micro switch.

8. The rotation device of claim 1, further comprising an angle sensor configured for detecting a rotation angle of the connecting plate, the angle sensor is selected from a group consisting of a potentiometric angle sensor, an optical encoder, a magnetic encoder, a resolver, a capacitive angle sensor, or a gyroscope.

9. A ceiling-mounted bracket, comprising:
the rotation device of claim 1; and
a display bracket, comprising a mounting frame and a folding mechanism, wherein the mounting frame is configured to mount the display, the mounting frame is arranged on the folding mechanism, and the folding mechanism is configured to drive the mounting frame to rotate about a second rotational axis to unfold or fold the mounting frame; and
wherein the connecting plate is detachably connected to the folding mechanism, the drive assembly of the rotation device is able to drive the folding mechanism to rotate about a first rotational axis, to cause the mounting frame to respectively rotate about the first rotational axis and the second rotational axis, and the first rotational axis is arranged intersecting the second rotational axis.

10. The ceiling-mounted bracket of claim 9, wherein the folding mechanism comprises a rotating member, a folding member, a connecting rod assembly, and a telescopic push rod, the connecting plate is detachably connected to the rotating member, the folding member is rotatably connected to the rotating member by the connecting rod assembly, one end of the telescopic push rod in an axial direction of the telescopic push rod is rotatably connected to the folding member, the other end of the telescopic push rod in the axial direction of the telescopic push rod is rotatably connected to the rotating member, the telescopic push rod is configured to drive the folding member to rotate about the second rotational axis relative to the rotating member, and the mounting frame is arranged on the folding member.

11. The ceiling-mounted bracket of claim 10, wherein the connecting rod assembly comprises a first hinge member, a second hinge member, and a third hinge member, two ends of the first hinge member are respectively hinged to the rotating member and the folding member, two ends of the second hinge member are respectively hinged to the first hinge member and the third hinge member, one end of the third hinge member is hinged to the folding member, and the other end of the third hinge member is slidably hinged to a slide groove on the rotating member.

12. The ceiling-mounted bracket of claim 9, wherein the display bracket is provided with a wiring channel configured to accommodate at least a portion of a wire of the display.

13. The ceiling-mounted bracket of claim 12, wherein the wiring channel comprises a wire groove formed on the display bracket.

14. The ceiling-mounted bracket of claim 13, wherein the display bracket comprises a plurality of wire clamps, the plurality of wire clamps are arranged on the folding mechanism in intervals and are each provided with a through hole, and the through holes of the plurality of wire clamps jointly form the wiring channel.
